(19) United States
(12) Patent Application Publication
(10) Pub. No.: US 2005/0185418 A1
(43) Pub. Date: Aug. 25, 2005

(54) Plastic optical fiber bundle with pitched illumination decorations

(76) Inventors: Chi-Tsung Peng, Hsin-Chu City (TW); Kuo-Hsiang Wen, Hsin-Chu City (TW)

Correspondence Address: J.C. Patents;Suite 250, 4 Venture, Irvine, CA, 92618, US

(21) Appl. No.: 10/783,527

(22) Filed: Feb. 19, 2004

(51) Int. Cl. F21V 7/04

(52) U.S. Cl. 362/555

(57) ABSTRACT

The present invention is related to a plastic optical fiber bundle with pitched illumination decorations. A single plastic optical fiber is reeled off and spun through a spinning nozzle. The surface of the plastic optical filer is then destructed in a pitched manner based on an appropriate pitched unit before the plastic optical fiber is cooled in a cooling area. When destructing the plastic optical fiber, only the outer layer is destructed without affecting the inner layer to produce a pitched destruction and illumination effect on the surface of the plastic optical fiber. A plastic optical fiber bundle is formed by individual plastic optical fibers with spaced illumination decorations. An illumination structure is installed on each end of the plastic optical fiber bundle with pitched illumination decorations and a luminary or a spotlight bulb is installed in each illumination structure of the plastic optical fiber bundle with illumination decorations. When the power is turned on, the luminary or spotlight bulb radiates light through the plastic optical fiber bundle with illumination decorations. The light is very soft without offending to eyes and can be used for different applications.

### BACKGROUND OF THE INVENTION

1. Field of the Invention

The present invention is related to plastic optical fiber bundle with spaced illumination decorations, especially to a plastic optical fiber bundle with a pitched destruction on its surface to produce illumination effect.

2. Description of the Prior Art

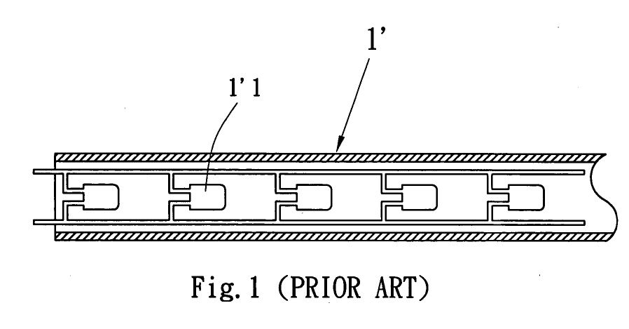

As shown in FIG. 1, ordinary connection lines have a string of bulbs with different colors in a transparent plastic pipes to produce illumination effect. The bulbs 1′1 of the bulb string structure 1′ connect to each other and produce an offending flashing effect when the power is turned on. However, this bulb string structure brings overheat easily and, thus, may cause fire. The production cost of this bulb string structure is high.

### SUMMARY OF THE INVENTION

The objective of the present invention is to provide a “plastic optical fiber bundle with pitched illumination decorations” without the disadvantage of the ordinary connection lines. The outer layer of a plastic optical fiber is destructed based on an appropriate spacing unit before it is finally shaped during the fiber drawing process, so that a spaced light leak effect is produced at the position where the surface of the plastic optical fiber is destructed in a spaced manner based on an appropriate spacing unit. The plastic optical fiber bundle with pitched illumination decorations of the present invention has a protection sleeve on its surface and a illumination structure on each end, so that it can be used as a illumination decoration for different applications.

The present invention is further described with the following figures:

FIG. 1 is an ordinary connection line;

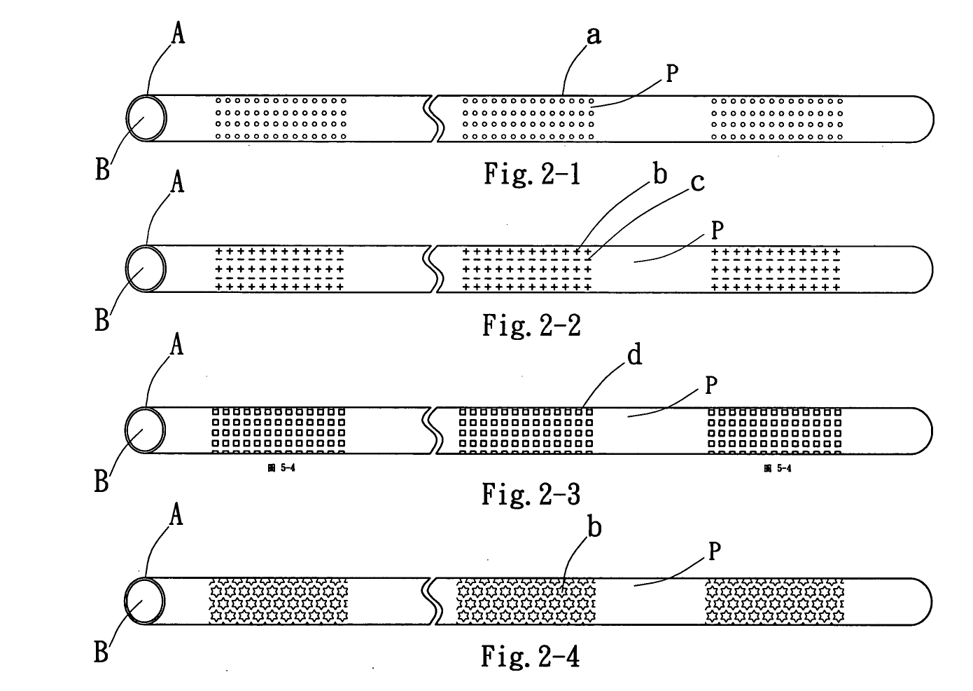

FIG. 2-1 shows the 1st view of the plastic optical fiber bundle of the present invention destructed in a pitched manner;

FIG. 2-2 shows the 2nd view of the plastic optical fiber bundle of the present invention destructed in a pitched manner;

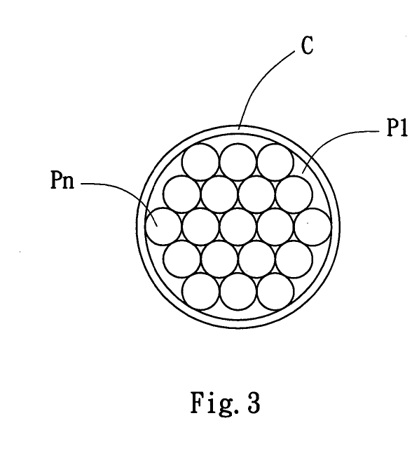

FIG. 2-3 shows the 3rd view of the plastic optical fiber bundle of the present invention destructed in a spaced manner;

FIG. 2-4 shows the 4th view of the plastic optical fiber bundle of the present invention destructed in a pitched manner;

FIG. 3 shows the cross-sectional view of the plastic optical fiber bundle of the present invention destructed in a pitched manner;

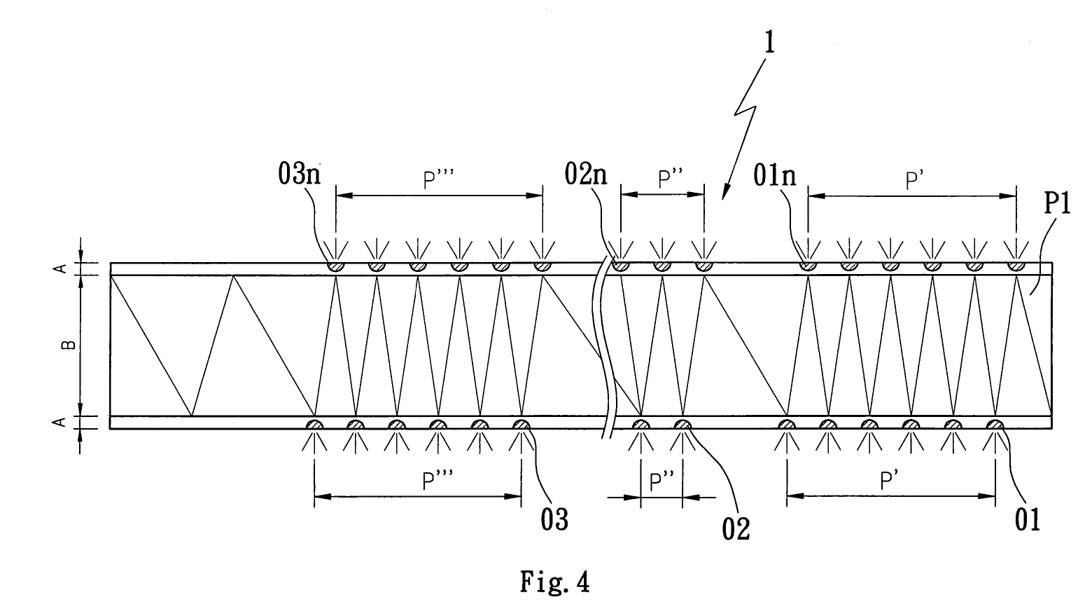

FIG. 4 shows the light leak schematic view of the plastic optical fiber bundle of the present invention destructed in a pitched manner;

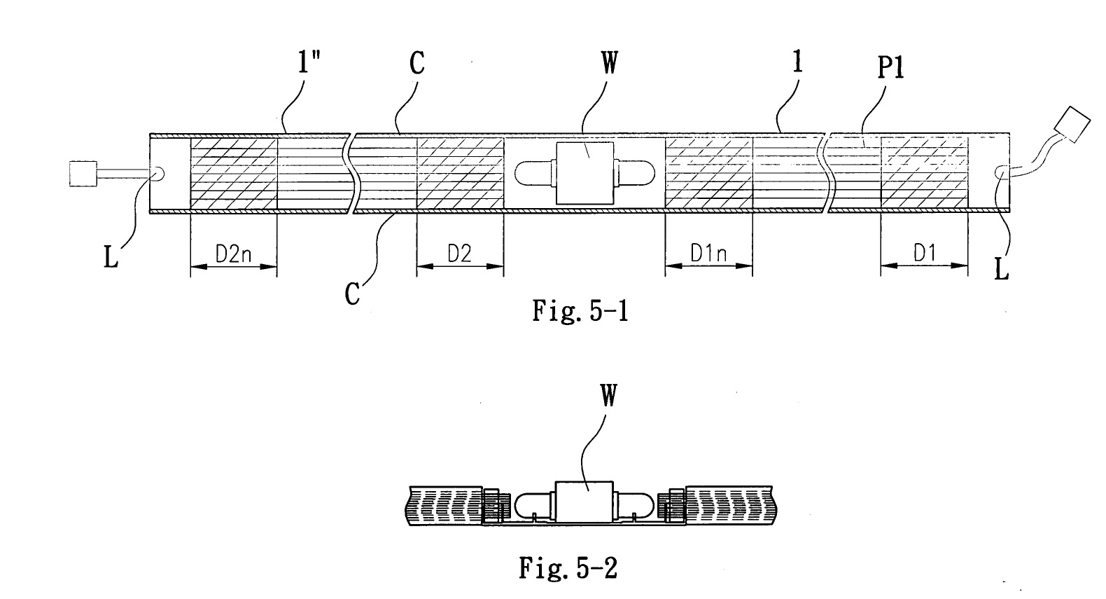

FIG. 5-1 shows the cross-sectional view of the embodiment of the present invention; and

FIG. 6 shows the side view of the present invention.

### DETAILED DESCRIPTION OF THE PREFERRED EMBODIMENTS

The present invention is a plastic optical fiber bundle with pitched illumination decorations. PMM A and PTFE B are fed simultaneously to form an outer and an inner layers respectively. The materials are molten and extruded and then spun through a spinning nozzle to form a molten two-layer plastic optical fiber. The surface of the molten plastic optical fiber P is destructed in a pitched manner based on an appropriate spacing unit formed by a special mold before the molten plastic optical fiber is cooled on a cooling plate. During the destruction process, only the outer layer is destructed without affecting the inner layer. The plastic optical fiber P with pitched destructions is distributed with spaced dot destructions (a) on its surface (FIG. 2-1); The plastic optical fiber P with spaced destructions is distributed with pitched “+” (b) and “−” (c) destructions on its surface (FIG. 2-2); The plastic optical fiber P with pitched destructions is distributed with pitched square (d) destructions on its surface (FIG. 2-3); The plastic optical fiber P with pitched destructions is distributed with pitched star (e) destructions on its surface (FIG. 2-4). As shown in FIG. 3, a plastic optical fiber bundle with pitched illumination decorations (1) is formed by individual plastic optical fibers with pitched illumination decorations P1˜Pn. A protection sleeve C is put onto the outer layer of the plastic optical fiber bundle with pitched illumination decorations 1.

The surface of the plastic optical fiber bundle with pitched illumination decorations 1 as shown in FIG. 4 is destructed and distributed with holes 01˜01n, 02˜02n and 03˜03n. The plastic optical fiber P with pitched destructions is distributed with spaces P′, P″, P′″ on its surface. When light radiates into the plastic optical fiber P with pitched destructions, the light is refracted to the P′, P″, P′″ distribution area to produce a light leak effect distributed in a pitched manner. When the power is turned on and the luminary L illuminates, the plastic optical fiber bundle with pitched illumination decorations 1 produces a light leak and decoration effect that is distributed in the pitched destruction areas D1, D1n, D2, D2n. A connector W is installed between the plastic optical fiber bundle with pitched illumination decorations 1 and the plastic optical fiber bundle with pitched illumination decorations 1′ for permanent connection.

The present invention is a plastic optical fiber bundle with pitched illumination decorations and the plastic optical fiber producing the light leak effect has the following characteristics:
(1) The plastic optical fiber is destructed in a spaced manner based on an appropriate unit during the fiber drawing process;
(2) The plastic optical fiber bundle with pitched illumination decorations of the present invention does not bring overheat or cause fire; and
(3) The connection line with pitched illumination decorations of the present invention radiates soft light that does not offend your eyes.

1. A plastic optical fiber bundle with pitched illumination decorations having a single plastic optical fiber, the surface of said plastic optical fiber being destructed in a pitched manner with a special mold before said plastic optical fiber forwarded to the cooling area, wherein an outer layer of said plastic optical fiber is distributed with pitched destructions formed based on an appropriate unit and only the out layer of said plastic optical fiber is destructed without affecting any inner layer of said plastic optical fiber; a plural of separate plastic optical fibers with pitched destructions form said plastic optical fiber bundle with pitched illumination decorations; said plastic optical fiber bundle produces a light leak effect when a power is turned on and an luminary or a spotlight bulb radiates light; the light is very soft without offending to eyes and can be used for different applications.

2. A plastic optical fiber bundle as cited in claim 1, wherein a connector is installed between two plastic optical fiber bundles with pitched illumination decorations for permanent connection.

3. A plastic optical fiber bundle as cited in claim 1, wherein a illumination structure is installed on each end of said plastic optical fiber bundles with pitched illumination decorations.

4. A plastic optical fiber bundle as cited in claim 3, wherein a luminary or a spotlight bulb is installed in said illumination structure of said plastic optical fiber bundles with pitched illumination decorations.
